(19) United States
(12) Patent Application Publication
(10) Pub. No.: US 2006/0135166 A1
(43) Pub. Date: Jun. 22, 2006

(54) Selective redirection of cellular calls to a local wireless endpoint

(75) Inventor: Dany Sylvain, Gatinuea (CA)

Correspondence Address: WITHROW & TERRANOVA, P.L.L.C., P.O. BOX 1287, CARY, NC, 27512, US

(73) Assignee: NORTEL NETWORKS LIMITED, St. Laurent (CA)

(21) Appl. No.: 11/014,353

(22) Filed: Dec. 16, 2004

(51) Int. Cl. H04Q 7/20

(52) U.S. Cl. 455/445; 455/422.1

(57) ABSTRACT

The present invention allows incoming calls intended for a mobile terminal, which is capable of supporting both local wireless and cellular communications, to be selectively routed to the mobile terminal via local wireless access in a controlled and efficient manner. In particular, the incoming call to the mobile terminal may be intended to be routed to the mobile terminal via cellular access. Upon receipt of the incoming call, a wireless office may operate to forward the call toward a service node along with redirection information. The service node will use the redirection information to determine how to process the incoming call.

### FIELD OF THE INVENTION

The present invention relates to communications, and in particular to redirecting calls intended for a mobile terminal over a cellular network to the mobile terminal over a local wireless network.

### BACKGROUND OF THE INVENTION

Today's telephony users generally have a mobile telephone receiving services through a cellular network and are becoming more reliant on mobile terminals for communications. In recent years, various local wireless technologies have been developed to facilitate communications over more limited areas than traditional cellular networks. Initially, these local wireless technologies were used primarily for imparting mobility to personal computers and to allow various types of devices to communicate with each other. There is now movement to incorporate local wireless technologies along with traditional cellular technologies in mobile terminals.

Since cellular technologies are predominantly based on circuit-switched connections and local wireless technologies are based on packet-based communications, there is an inherent incompatibility between the local wireless and cellular technologies. Thus, there is a need to facilitate communications over both the cellular and local wireless networks using one mobile terminal. There is a further need to route incoming calls to the mobile terminal through either the cellular or local wireless network.

### SUMMARY OF THE INVENTION

The present invention allows incoming calls intended for a mobile terminal that is capable of supporting both local wireless and cellular communications to be selectively routed to the mobile terminal via local wireless access in a controlled and efficient manner. In particular, the incoming call to the mobile terminal may be intended to be routed to the mobile terminal via cellular access. Upon receipt of the incoming call, a wireless office may operate to forward the call toward a service node along with redirection information. The service node will use the redirection information to determine how to process the incoming call. The redirection information may be associated with the mobile terminal and be used by the service node to identify an appropriate address to which the call should be routed for the mobile terminal using local wireless access. Upon obtaining the address, the service node can effect establishment of the call with the mobile terminal via local wireless access. As such, the call may be routed through an appropriate gateway interconnecting a packet network and the PSTN, which includes the wireless office and any other aspects of a cellular network.

In one embodiment, the wireless office will access a location register, such as a home location register (HLR), to determine how to route the call. The location register will respond with instructions to route the incoming call towards the service node. The location register may provide a directory number associated with the service node and terminating at the gateway. Upon forwarding the call to the gateway, the gateway will be able to route the incoming call and the associated information to the service node. Depending on the embodiment, the location register may be pre-provisioned or may be updated by the service node. In one embodiment, the mobile terminal can register directly with the service node, wherein the service node will instruct the location register to direct the wireless office to forward incoming calls intended for the mobile terminal towards the service node.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a communication environment according to one embodiment of the present invention.

FIGS. 2A and 2B show a communication flow diagram illustrating a first call flow scenario according to one embodiment of the present invention.

FIGS. 3A and 3B show a communication flow diagram illustrating a second call flow scenario according to one embodiment of the present invention.

FIG. 4 is a block representation of a service node according to one embodiment of the present invention.

FIG. 5 is a block representation of a home location register according to one embodiment of the present invention.

FIG. 6 is a block representation of a mobile terminal according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

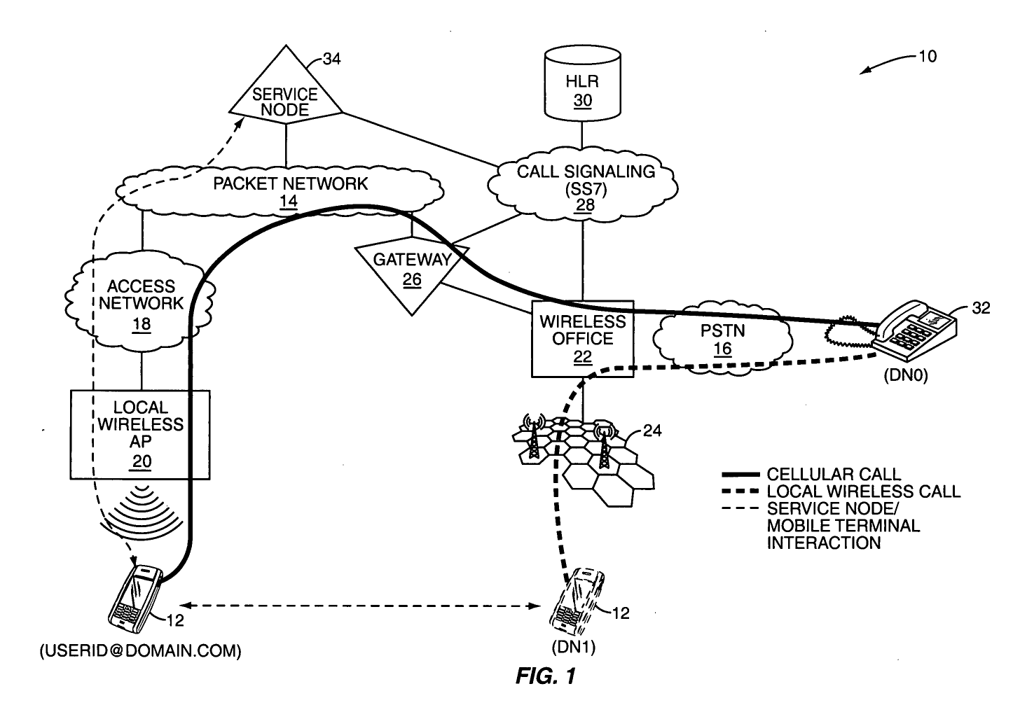

Turning now to FIG. 1, a communication environment 10 is shown wherein a mobile terminal 12 is configured to support both cellular and local wireless communications. Cellular communications will involve technologies such as code division multiple access (CDMA), time division multiple access (TDMA), orthogonal frequency division multiple access (OFDM), or other available cellular communication technologies known to those skilled in the art. Local wireless communications involve those communication technologies that provide wireless communications in a much more limited range with respect to traditional cellular communications. Local wireless communication technologies may include the IEEE's 802.11 standards for local wireless area networking, Bluetooth, or other relatively limited range wireless communication technologies.

Since the mobile terminal 12 can support either local wireless or cellular communications, the mobile terminal 12 will generally access a packet network 14 via local wireless access, or a public switched telephone network (PSTN) 16, which would include traditional cellular as well as wireline networks, via cellular access. In particular, local wireless access to the packet network 14 is provided by an access network 18 and an appropriate local wireless access point (AP) 20, wherein the access network 18 connects the local wireless access point 20 to the packet network 14 directly or indirectly. The local wireless access point 20 will support local wireless communications with the mobile terminal 12 and provide access to the access network 18. Cellular access is generally provided by a wireless office 22, such as a mobile switching center, and an associated network of base stations 24, which provide cellular access for the mobile terminal 12 in traditional fashion.

Interworking between the packet network 14 and the PSTN 16 is generally afforded by a gateway 26, which will provide the necessary conversion between packet-based communication sessions and circuit-switched calls that are supported by the wireless office 22 and the PSTN 16. For clarity, the gateway 26 is shown as being coupled directly between the wireless office 22 and the packet network 14.

Call signaling for cellular communications is generally controlled through a signaling system, such as a Signaling System 7 (SS7) network 28, which is shown as interfacing with the wireless office 22 and the gateway 26, as well as with a home location register (HLR) 30. The home location register 30 is generally associated with the cellular mode of the mobile terminal 12. The HLR 30 is used to store the current location and contact information for the mobile terminal 12 for wireless access. As such, remote call control entities can access the HLR 30 to obtain the location and contact information for the mobile terminal 12 when it is roaming in another cellular network. When roaming, location and contact information for the mobile terminal 12 will be sent to the HLR 30 as necessary. The HLR 30 may also be configured to establish call forwarding or call redirection rules for incoming calls that are intended for the mobile terminal 12 and handled via the cellular network. For the present invention, redirection information associated with the mobile terminal 12 is stored in the HLR 30 such that when an incoming call is intended for the mobile terminal 12, it may be redirected to the mobile terminal 12 via local wireless access instead of cellular access, as desired.

As illustrated in FIG. 1, a call originating from a telephone terminal 32 via the PSTN 16 may be routed to the mobile terminal 12 as a cellular call through the wireless office 22 and the network of base stations 24 or as a local wireless call through the gateway 26, packet network 14, access network 18, and local wireless access point 20. For calls involving the packet network 14, a packet-based call control entity, referred to as a service node 34, is used. As illustrated, the mobile terminal 12, when operating in a local wireless access mode, can communicate with the service node 34 to facilitate registration, call establishment, call termination, or any other call-based or session-based communication functions. The service node 34 may act as a proxy for the mobile terminal 12, when operating in a local wireless mode. Further, the service node 34 may interact with the HLR 30, gateway 26, or other entities associated with the SS7 network 28, as will be illustrated below.

For reference, calls intended to be routed to the mobile terminal 12 using cellular access will be referred to as cellular calls, and those intended to be routed to the mobile terminal 12 using local wireless access will be referred to as local wireless calls. Either cellular or local wireless calls may originate from any network, including the PSTN 16 as will be described herein. The present invention allows cellular calls intended for the mobile terminal 12 to be redirected as local wireless calls, which are routed to the mobile terminal 12 using local wireless access, which is illustrated as being that provided by the access network 18 and local wireless access point 20. As such, cellular calls will be routed to the wireless office 22, which will access the HLR 30 to determine how to route the incoming call. In certain situations, the HLR 30 will direct the wireless office 22 to redirect the incoming call to the mobile terminal 12 using local wireless access.

For reference, the telephone terminal 32 is associated with a directory number DN0, and the mobile terminal 12 is associated with directory number DN1 for cellular calls and an address of userid@domain.com for local wireless calls. Cellular calls to and from the mobile terminal 12 will be associated with directory number DN1, and local wireless calls to and from the mobile terminal 12 will be associated with the address userid@domain.com. Thus, for the purposes of illustration, and incoming call intended for the mobile terminal 12 using directory number DN1 may be rerouted to the mobile terminal 12 using the address userid@domain.com. Again, the HLR 30 will provide the necessary information to allow the wireless office 22 to determine whether the incoming call should be routed to the mobile terminal 12 using directory number DN1, the address userid@domain.com, or be processed in some other fashion, such as routing the call to a voicemail system (not shown) forwarding the call to another directory number or address, rejecting the call, or any other call processing function as desired. Any redirection instructions may be provided to the HLR 30 during initial provisioning of the HLR 30 or may be provided dynamically. The redirection information may be provided by different entities, including the service node 34, the wireless office 22, the mobile terminal 12, or other device in a direct or indirect fashion.

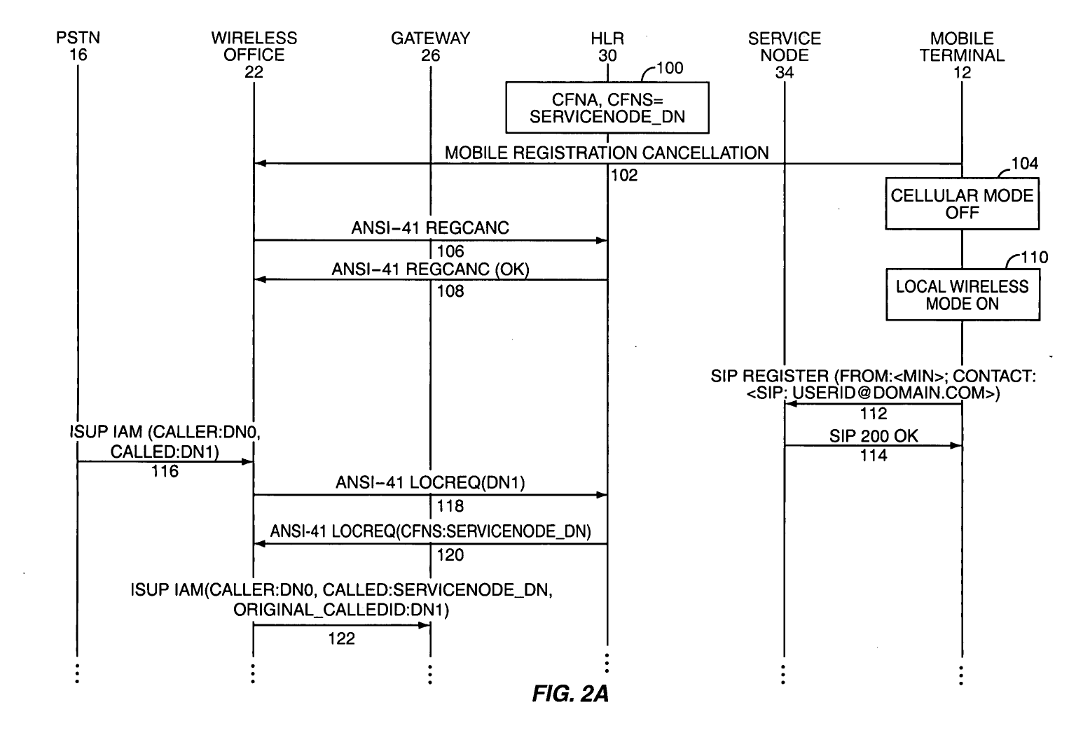

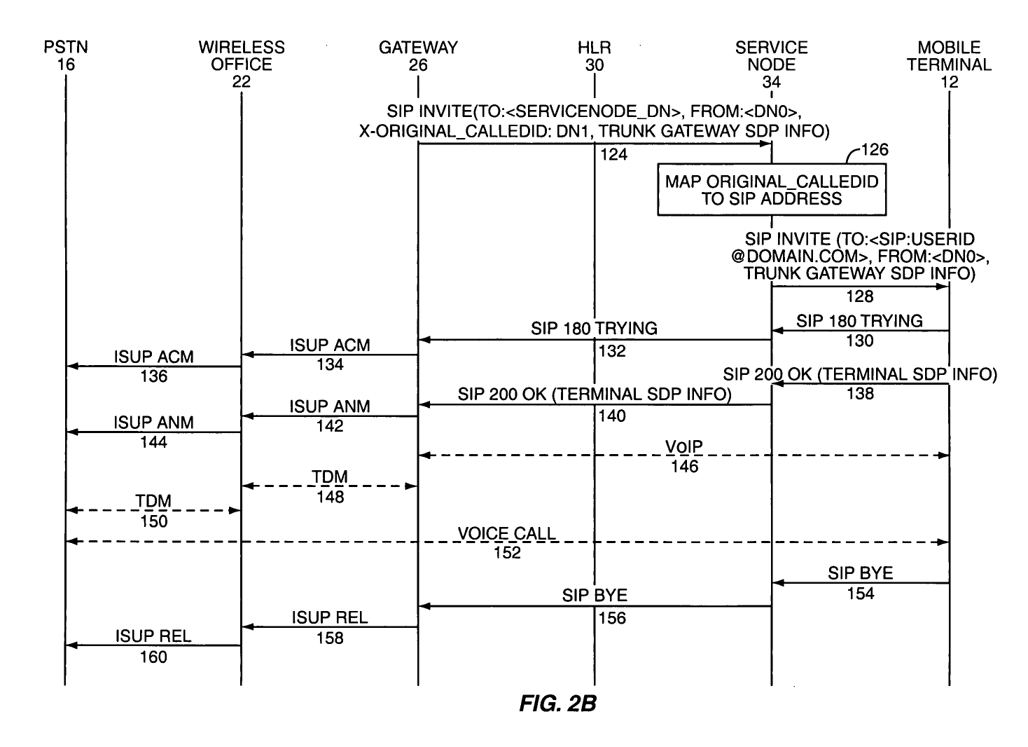

With reference to FIGS. 2A and 2B, a communication flow is illustrated wherein the HLR 30 is already provided redirection information. For the following communication flow diagrams, assume that cellular-based signaling uses CDMA and will use the ANSI-41 CDMA standard for call signaling. Further, assume packet-based communication sessions and signaling are afforded using the Session Initiation Protocol (SIP). In this embodiment, the redirection information is associated either with a call forward no answer (CFNA) or call forward no service (CFNS) feature, wherein calls are forwarded when there is no answer during a cellular call or no service for a cellular call, and the incoming call is redirected to a directory number associated with the service node 34, which is acting as a proxy for the mobile terminal 12 when operating in a local wireless access mode.

Accordingly, the HLR 30 is programmed to redirect incoming cellular calls intended for directory number DN1 of the mobile terminal 12 when there is no answer or no service to the directory number servicenode DN (step 100). At this point, assume the mobile terminal 12 is in the process of switching from a cellular mode to a local wireless mode, and initially sends a mobile registration cancellation message to the wireless office 22 (step 102) and then ceases to operate in cellular mode (step 104). Upon receiving the mobile registration cancellation message, the wireless office 22 will send a Registration Cancellation (REGCANC) message to the HLR 30, which indicates that there will be no cellular service for the mobile terminal 12 (step 106). The HLR 30 will respond with a REGCANC (OK) message (step 108). During this process, the mobile terminal 12 will begin operation in a local wireless mode (step 110). When local wireless access is available, the mobile terminal 12 will send a SIP Register message to effect registration of the mobile terminal 12 with the service node 34 (step 112). The registration information provided with the SIP Register message may include the mobile identification number (MIN) of the mobile terminal 12, as well as the SIP address of userid@domain.com for the mobile terminal 12. Once registered, the service node 34 will send a SIP 200 OK message back toward the mobile terminal 12 (step 114).

Next, assume that an incoming cellular call is initiated from the telephone terminal 32 to the mobile terminal 12 using directory number DN1. As such, an Integrated Services User Part (ISUP) Initial Address Message (IAM) is generated by the PSTN 16 and sent to the wireless office 22 (step 116). The ISUP IAM will identify the caller as the telephone terminal 32 associated with directory number DNO and the called party as the mobile terminal 12 associated with directory number DN1. The wireless office 22 will use this information to query the HLR 30 to obtain routing information for the incoming call. As such, the wireless office 22 may send an ANSI41 Location Request (LOCREQ) message identifying directory number DN1 to the HLR 30 (step 118), which will use the directory number DN1 to determine how the incoming call should be routed. In this instance, the wireless office 22 has previously cancelled the cellular access registration for the mobile terminal 12, and the HLR 30 will determine that the incoming call should be directed to the service node 34 using directory number servicenode_DN. Accordingly, the HLR 30 will send a LOCREQ Response message that will instruct the wireless office 22 to redirect the incoming call to servicenode_DN (step 120).

As instructed, the wireless office 22 will route the call toward the service node 34 by sending an ISUP IAM toward the device associated with servicenode_DN. Since the service node 34 resides on the packet network 14, servicenode_DN is associated with the gateway 26, which will recognize that incoming calls to servicenode_DN should be further routed using the Session Initiation Protocol to the service node 34. The ISUP IAM will identify the caller using directory number DN0, the called party using servicenode_DN, and will also include the originally intended directory number DN1. The gateway 26 will receive the ISUP IAM (step 122) and then initiate a SIP Invite message toward the service node 34 (step 124). The SIP Invite message will be sent to servicenode_DN and identify the caller using directory number DNO, provide the originally called information DN1, and provide any Session Description Protocol (SDP) information for establishing a communication session with the gateway 26. In this embodiment, the gateway 26 is a trunk gateway, wherein telephony trunks are used to connect the wireless office 22 to the gateway 26.

The service node 34 will process the received information provided in the SIP Invite message and map the originally called information to the appropriate SIP address, which is userid@domain.com (step 126). Acting as a proxy for the mobile terminal 12, the service node 34 will forward the SIP Invite message to the mobile terminal 12 using the SIP address, identifying the calling party with directory number DNO, and providing the trunk gateway SDP information (step 128). The mobile terminal 12 will respond to the SIP Invite message with a SIP 180 Trying message (step 130), which is received by the service node 34 and forwarded to the trunk gateway 26 (step 132). At this point, the mobile terminal 12 may provide an alert that an incoming call is being received, and in particular, provide an indication that the call is being received via local wireless access, if such capability is provided or desired. The gateway 26 will respond to receiving the SIP 180 Trying message by initiating an ISUP Address Complete message (ACM) (step 134), which is received by the wireless office 22 and forwarded through the PSTN 16 (step 136) in response to the original ISUP IAM (of step 116).

Once the mobile terminal 12 is answered, a SIP 200 OK message is generated and sent to the service node 34, including the SDP information for the mobile terminal 12 (step 138). The service node 34 will forward the SIP 200 OK message with the mobile terminal's SDP information to the trunk gateway 26 (step 140), which will respond by sending an ISUP Answer message (ANM) to the wireless office 22 (step 142). The wireless office 22 will forward the ISUP ANM through the PSTN 16 to indicate that that mobile terminal 12 has been answered (step 144). At this point, the mobile terminal 12 will have the SDP information for the gateway 26, and the gateway 26 will have the SDP information for the mobile terminal 12. Since the SDP information provides all the requisite addressing, port, and codec information required for communications, a Voice-over-Packet (VoP) or Voice-over-Internet-Protocol (VolP) session is established for the call between the gateway 26 and the mobile terminal 12 (step 146). For the cellular connection, a Time Division Multiplexed (TDM) connection is established between the wireless office 22 and the gateway 26 (step 148), as well as between the wireless office and the telephone terminal 32 through the PSTN 16 (step 150). As such, there is a connection or session between the mobile terminal 12 and the telephone terminal 32 using local wireless access for the voice call (step 152). At this point, bidirectional communications are afforded.

When the call ends, the mobile terminal 12 may send a SIP Bye message to the service node 34 (step 154), which will forward the SIP Bye message to the gateway 26 (step 156), which will end the packet-based VolP session between the gateway 26 and the mobile terminal 12. The gateway 26 will also send an ISUP Release (REL) message toward the wireless office 22 (step 158), which will forward the ISUP Release message through the PSTN 16 (step 160). At this point, the connection between the telephone terminal 32 and the gateway 26 is torn down.

From the above, incoming cellular calls intended for the mobile terminal 12 are initially received by the wireless office 22, which may access an HLR 30 to determine if the call should be redirected to the mobile terminal 12 using local wireless access instead of cellular access, if certain conditions apply or certain instructions are provided. Redirection will be based on redirection information, which may include an address associated with a local wireless access call to the mobile terminal 12. In this embodiment, the redirection information was a directory number associated with the service node 34; however, the directory number causes the incoming call to be routed to the gateway 26 prior to being further routed to the mobile terminal 12 using local wireless access.

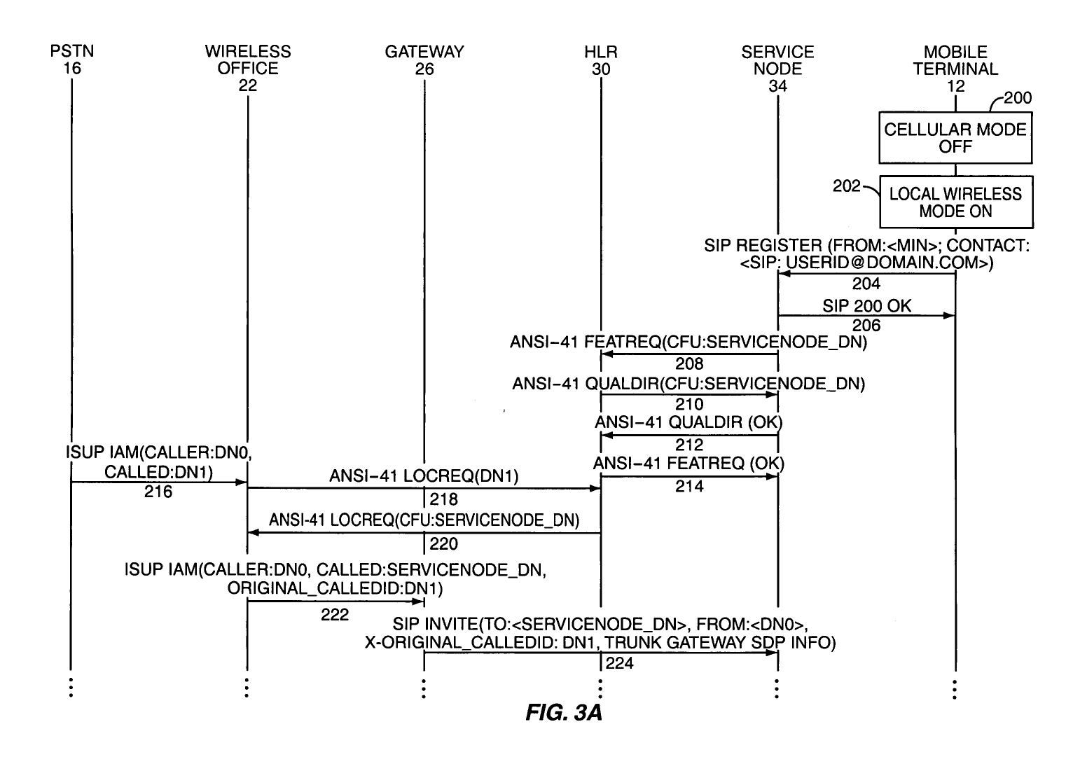

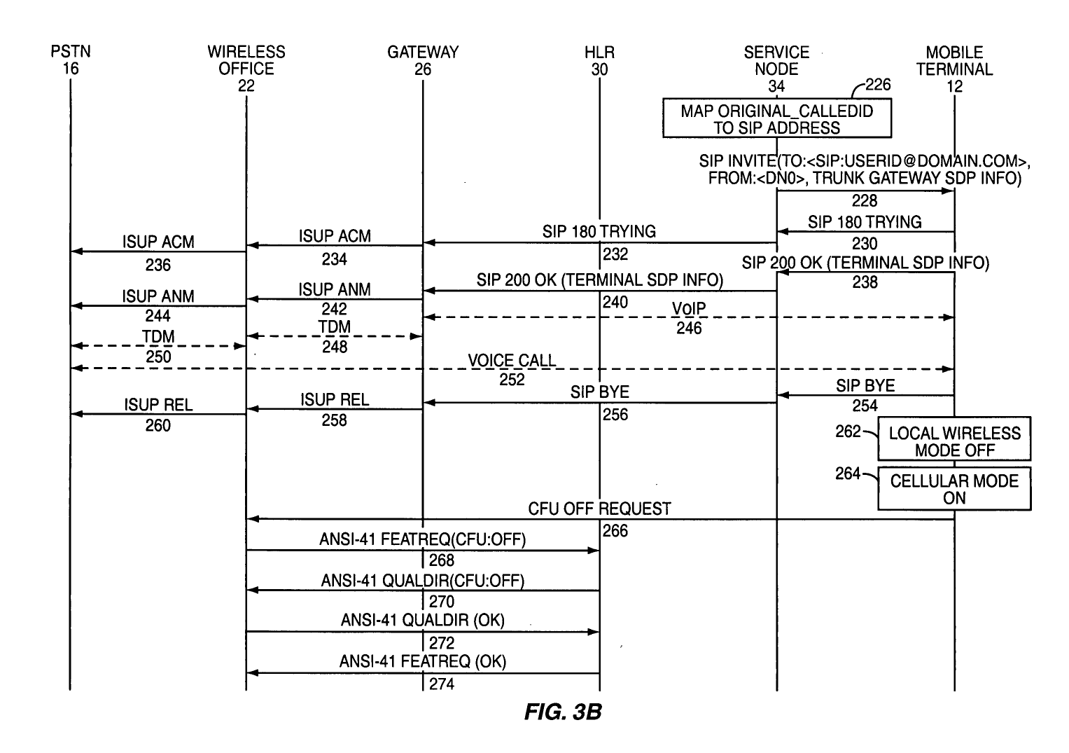

Turning now to FIGS. 3A and 3B, another illustrated communication flow is provided. Assume that the mobile terminal 12 deactivates its cellular mode (step 200) and activates a local wireless access mode (step 202). Upon activating the local wireless access mode, the mobile terminal 12 will send a SIP Register message to the service node 34 (step 204), which will reply with a SIP 200 OK message (step 206). At this point, the service node 34 will dynamically interact with the HLR 30 to provide redirection information in the form of a call forwarding number, which in this case is again servicenode_DN. In the illustrated embodiment, the service node 34 will send an ANSI-41 Feature Request (FEATREQ) message instructing the HLR 30 to establish a call forward unconditional (CFU) configuration wherein all cellular calls intended for the mobile terminal 12 using directory number DN1 will be forwarded toward the directory number associated with the service node 34 (servicenode_DN) (step 208). The HLR 30 will then send an ANSI41 Qualified Direct (QUALDIR) message back to the service node 34 for confirmation (step 210). The service node 34 will respond with an ANSI-41 QUALDIR (OK) message to the HLR 30 (step 212), which will respond with an ANSI-41 FEATREQ (OK) message (step 214) to comply with the ANSI-41 specifications. At this point, the service node 34 is emulating a wireless office acting on behalf of the mobile terminal 12.

Next, assume that an incoming cellular call is initiated from the telephone terminal 32 to the mobile terminal 12 using directory number DN1. As such, an ISUP IAM is generated by the PSTN 16 and sent to the wireless office 22 (step 216). The ISUP IAM will identify the caller as the telephone terminal 32 associated with directory number DN0 and the called party as the mobile terminal 12 associated with directory number DN1. The wireless office 22 will use this information to query the HLR 30 to obtain routing information for the incoming call. As such, the wireless office 22 may send an ANSI-41 Location Request message identifying directory number DN1 to the HLR 30 (step 218), which will use the directory number DN1 to determine how the incoming call should be routed. In this instance, the wireless office 22 has previously cancelled the cellular access registration for the mobile terminal 12, and the HLR 30 will determine that the incoming call should be directed to the service node 34 using directory number servicenode_DN. Accordingly, the HLR 30 will send a LOCREQ Response message that will instruct the wireless office 22 to redirect the incoming call to servicenode_DN (step 220), as dictated when the call forwarding unconditional feature is invoked.

As instructed, the wireless office 22 will route the call toward the service node 34 by sending an ISUP IAM toward the device associated with servicenode_DN. Since the service node 34 resides on the packet network 14, servicenode_DN is associated with the gateway 26, which will recognize that incoming calls to servicenode_DN should be further routed using the Session Initiation Protocol to the service node 34. The ISUP IAM will identify the caller using directory number DN0, the called party using servicenode_DN, and will also include the originally intended directory number DN1. The gateway 26 will receive the ISUP IAM (step 222) and then initiate a SIP Invite message toward the service node 34 (step 224). The SIP Invite message will be sent to servicenode_DN and identify the caller using directory number DN0, provide the originally called information DN1, and provide any SDP information for establishing a communication session with the gateway 26. In this embodiment, the gateway 26 is a trunk gateway, wherein telephony trunks are used to connect the wireless office 22 to the gateway 26.

The service node 34 will process the received information provided in the SIP Invite message and map the original called information to the appropriate SIP address, which is userid@domain.com (step 226). Acting as a proxy for the mobile terminal 12, the service node 34 will forward the SIP Invite message to the mobile terminal 12, using the SIP address, and identifying the calling party with directory number DNO and providing the trunk gateway SDP information (step 228). The mobile terminal 12 will respond to the SIP Invite message with a SIP 180 Trying message (step 230), which is received by the service node 34 and forwarded to the trunk gateway 26 (step 232). At this point, the mobile terminal 12 may provide an alert that an incoming call is being received, and in particular, provide an indication that the call is being received via local wireless access, if such capability is provided or desired. The gateway 26 will respond to receiving the SIP 180 Trying message by initiating an ISUP ACM (step 234), which is received by the wireless office 22 and forwarded through the PSTN 16 (step 236) in response to the original ISUP IAM (of step 116).

Once the mobile terminal is answered, a SIP 200 OK message is generated and sent to the service node 34, including the SDP information for the mobile terminal 12 (step 238). The service node 34 will forward the SIP 200 OK message with the mobile terminal's SDP information to the trunk gateway 26 (step 240), which will respond by sending an ISUP ANM to the wireless office 22 (step 242). The wireless office 22 will forward the ISUP ANM through the PSTN 16 to indicate that that mobile terminal 12 has been answered (step 244). At this point, the mobile terminal 12 will have the SDP information for the gateway 26, and the gateway 26 will have the SDP information for the mobile terminal 12. Since the SDP information provides all the requisite addressing, port, and codec information required for communications, a VoP or VolP session is established for the call between the gateway 26 and the mobile terminal 12 (step 246). For the cellular connection, a TDM connection is established between the wireless office 22 and the gateway 26 (step 248), as well as between the wireless office and the telephone terminal 32 through the PSTN 16 (step 250). As such, there is a connection or session between the mobile terminal 12 and the telephone terminal 32 using local wireless access for the voice call (step 252). At this point, bidirectional communications are afforded.

When the call ends, the mobile terminal 12 may send a SIP Bye message to the service node 34 (step 254), which will forward the SIP Bye message to the gateway 26 (step 256), which will end the packet-based VolP session between the gateway 26 and the mobile terminal 12. The gateway 26 will also send an ISUP Release message toward the wireless office 22 (step 258), which will forward the ISUP Release message through the PSTN 16 (step 260). At this point, the connection between the telephone terminal 32 and the gateway 26 is torn down.

Assume now that the mobile terminal 12 deactivates the local wireless mode (step 262) and activates the cellular mode (step 264). Accordingly, the mobile terminal 12 will send a message to turn the call forward unconditional off to the wireless office 22 (step 266). In response, the wireless office 22 will send an ANSI-41 Feature Request message to the HLR 30 instructing it to turn the call forward unconditional off (step 268). According to the ANSI-41 protocol, the HLR 30 will respond with a Qualified Direct message indicating that the call forward unconditional is turned off (step 270). The wireless office 22 will send an ANSI-41 Qualified Direct OK message to the HLR 30 (step 272), which will send an ANSI-41 Feature Request OK message back to the wireless office 22 (step 274). At this point, the HLR 30 will operate in traditional fashion, and will not redirect incoming cellular access calls to the mobile terminal 12 using local wireless access, but will instead allow the calls to proceed in normal fashion through cellular access or as the HLR 30 is otherwise configured. Again, the call forward unconditional programming will include redirection information used by the HLR 30 to direct the wireless office 22 in routing the incoming cellular access calls intended for the mobile terminal 12. The redirection information may take many forms, but will generally provide the wireless office 22 with sufficient information to effectively redirect the incoming cellular access call toward the packet network 14, such that the incoming call can be established with the mobile terminal 12 using local wireless access.

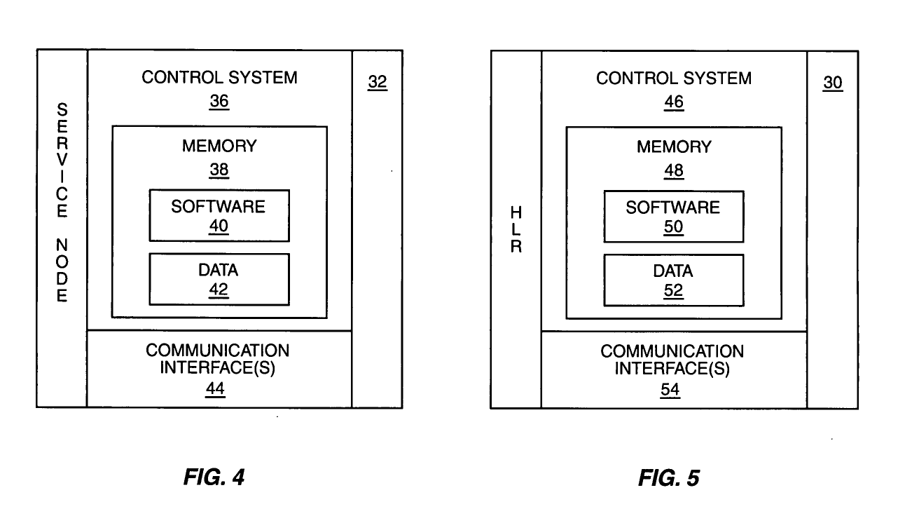

Turning now to FIG. 4, a block representation of a service node 34 is illustrated as having a control system 36 with sufficient memory 38 for the software 40 and data 42 requisite to provide the operation described above. The control system 36 will also be associated with one or more communication interfaces 44 to facilitate communications with the various communication entities.

The HLR 30 is illustrated in FIG. 5 as having a control system 46 with sufficient memory 48 for software 50 and data 52 necessary for operation. The control system 46 is also associated with one or more communication interfaces 54 to facilitate interaction with the call signaling network 28, wireless office 22, or other call signaling entities, including the service node 34 directly or indirectly.

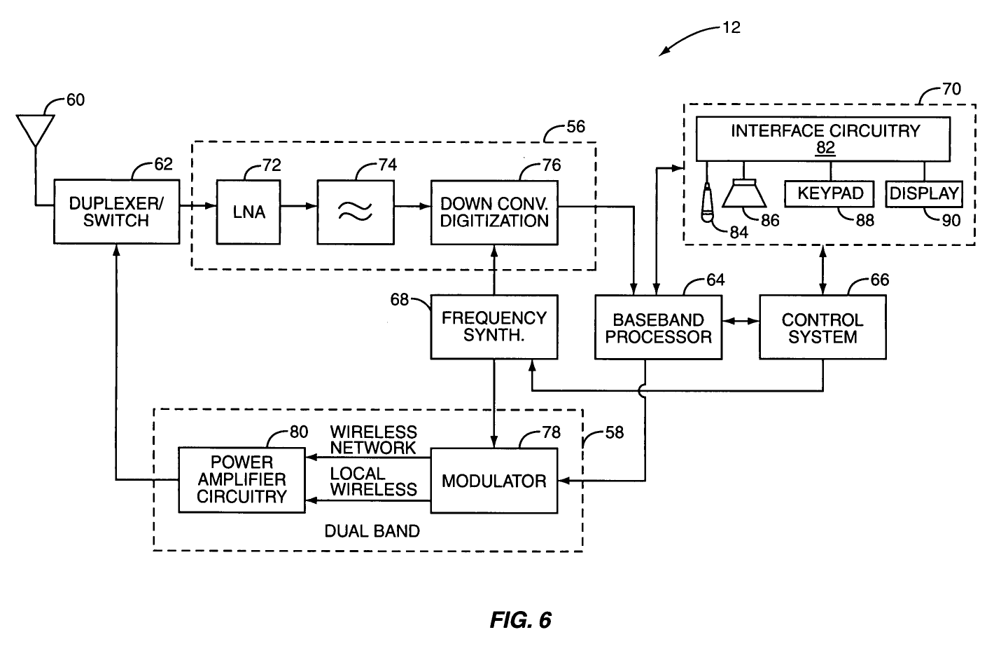

The basic architecture of the mobile terminal 12 is represented in FIG. 6 and may include a receiver front end 56, a radio frequency transmitter section 58, an antenna 60, a duplexer or switch 62, a baseband processor 64, a control system 66, a frequency synthesizer 68, and an interface 70. The receiver front end 56 receives information bearing radio frequency signals from one or more remote transmitters provided by a base station. A low noise amplifier 72 amplifies the signal. A filter circuit 74 minimizes broadband interference in the received signal, while downconversion and digitization circuitry 76 downconverts the filtered, received signal to an intermediate or baseband frequency signal, which is then digitized into one or more digital streams. The receiver front end 56 typically uses one or more mixing frequencies generated by the frequency synthesizer 68. The baseband processor 64 processes the digitized received signal to extract the information or data bits conveyed in the received signal. This processing typically comprises demodulation, decoding, and error correction operations. As such, the baseband processor 64 is generally implemented in one or more digital signal processors (DSPs).

On the transmit side, the baseband processor 64 receives digitized data, which may represent voice, data, or control information, from the control system 66, which it encodes for transmission. The encoded data is output to the transmitter 58, where it is used by a modulator 78 to modulate a carrier signal that is at a desired transmit frequency. Power amplifier circuitry 80 amplifies the modulated carrier signal to a level appropriate for transmission, and delivers the amplified and modulated carrier signal to the antenna 60 through the duplexer or switch 62.

As noted above, the mobile terminal 12 is able to communicate with the wireless access point 20 as well as with the cellular network of base stations 24. Accordingly, the receiver front end 56, baseband processor 64, and radio frequency transmitter section 58 cooperate to provide either a wireless interface for the network of base stations 24 or the local wireless interface for the local wireless access point 20. These functions may be implemented using redundant circuitry, or by configuring common circuitry to operate in different modes. The configuration of the mobile terminal 12 will be dictated by economics and designer choice.

A user may interact with the mobile terminal 12 via the interface 70, which may include interface circuitry 82 associated with a microphone 84, a speaker 86, a keypad 88, and a display 90. The interface circuitry 82 typically includes analog-to-digital converters, digital-to-analog converters, amplifiers, and the like. Additionally, it may include a voice encoder/decoder, in which case it may communicate directly with the baseband processor 64. The microphone 84 will typically convert audio input, such as the user's voice, into an electrical signal, which is then digitized and passed directly or indirectly to the baseband processor 64. Audio information encoded in the received signal is recovered by the baseband processor 64, and converted by the interface circuitry 82 into an analog signal suitable for driving the speaker 86. The keypad 88 and display 90 enable the user to interact with the mobile terminal 12, input numbers to be dialed, address book information, or the like, as well as monitor call progress information.

Those skilled in the art will recognize improvements and modifications to the preferred embodiments of the present invention. All such improvements and modifications are considered within the scope of the concepts disclosed herein and the claims that follow.

What is claimed is:

1. A method comprising:
detecting an incoming call originally intended to be routed to a mobile terminal via cellular access and redirected by a wireless office facilitating the cellular access, the incoming call including information associated with the mobile terminal; and
determining how to further process the incoming call based on the information associated with the mobile terminal

2. The method of claim 1 further comprising routing the incoming call to the mobile terminal via local wireless access using a local wireless address, and wherein determining how to further process the incoming call comprises identifying the local wireless address for the mobile terminal based on the information associated with the cellular access for the mobile terminal.

3. The method of claim 2 further comprising facilitating establishment of the incoming call with the mobile terminal using the local wireless address.

4. The method of claim 3 wherein the incoming call is established through a local wireless access point, a packet network, a gateway interconnecting the packet network and a public switched telephone network, and the public switched telephone network.

5. The method of claim 2 wherein the mobile terminal is adapted to support both local wireless communications via the local wireless access and cellular communication via the cellular access.

6. The method of claim 1 wherein the wireless office sends a query to a location register to determine where to route the incoming call and the location register responds to the query by directing the wireless office to redirect the incoming call towards a service node, which performs the detecting and determining steps.

7. The method of claim 6 wherein the location register responds to the query by directing the wireless office to redirect the incoming call towards the service node when forwarding incoming calls originally intended for the mobile terminal via the cellular access as applicable.

8. The method of claim 6 wherein the location register is provisioned to respond to the query by directing the wireless office to redirect the incoming call towards the service node.

9. The method of claim 6 further comprising:
receiving registration information from the mobile terminal via the cellular access; and
instructing the location register to respond to the query by directing the wireless office to redirect the incoming call towards the service node.

10. The method of claim 6 wherein the location register responds to the query by providing a directory number associated with the service node.

11. The method of claim 10 wherein the directory number corresponds to a gateway interfacing a packet network through which the local wireless access is available, the gateway adapted to forward the incoming call from the wireless office to the service node.

12. The method of claim 1 wherein the information associated with the mobile terminal is further associated with obtaining the cellular access to the mobile terminal.

13. The method of claim 12 wherein the information associated with the mobile terminal is called party identification corresponding with the cellular access to the mobile terminal.

14. The method of claim 12 wherein the information associated with the mobile terminal is a directory number associated with the cellular access to the mobile terminal.

15. The method of claim 1 further comprising:
detecting a plurality of incoming calls originally intended to be routed to any one of a plurality of mobile terminals via the cellular access and redirected by any one of a plurality of wireless offices facilitating the cellular access, the incoming calls including information associated with a corresponding one of the plurality of mobile terminals to which the incoming calls are intended; and
determining how to further process the incoming calls based on the information associated with the corresponding one of the plurality of mobile terminals.

16. A system method comprising:
at least one communication interface; and
a control system associated with the at least one communication interface and adapted to:
detect an incoming call originally intended to be routed to a mobile terminal via cellular access and redirected by a wireless office facilitating the cellular access, the incoming call including information associated with the mobile terminal; and
determine how to further process the incoming call based on the information associated with the mobile terminal.

17. The system of claim 16 wherein the control system is further adapted to route the incoming call to the mobile terminal via local wireless access using a local wireless address, and wherein to determine how to further process the incoming call, the control system is further adapted to identify the local wireless address for the mobile terminal based on the information associated with the cellular access for the mobile terminal.

18. The system of claim 17 wherein the control system is further adapted to facilitate establishment of the incoming call with the mobile terminal using the local wireless address.

19. The system of claim 18 wherein the incoming call is established through a local wireless access point, a packet network, a gateway interconnecting the packet network and a public switched telephone network, and the public switched telephone network.

20. The system of claim 17 wherein the mobile terminal is adapted to support both local wireless communications via the local wireless access and cellular communication via the cellular access.

21. The system of claim 16 wherein the wireless office sends a query to a location register to determine where to route the incoming call and the location register responds to the query by directing the wireless office to redirect the incoming call towards a service node, which performs the detecting and determining steps.

22. The system of claim 21 wherein the location register responds to the query by directing the wireless office to redirect the incoming call towards the service node when forwarding incoming calls originally intended for the mobile terminal via cellular access as applicable.

23. The system of claim 21 wherein the location register is provisioned to respond to the query by directing the wireless office to redirect the incoming call towards the service node.

24. The system of claim 21 wherein the control system is further adapted to:
receive registration information from the mobile terminal via the cellular access; and
instruct the location register to location register to respond to the query by directing the wireless office to redirect the incoming call towards the service node.

25. The system of claim 21 wherein the location register responds to the query by providing a directory number associated with the service node.

26. The system of claim 25 wherein the directory number corresponds to a gateway interfacing a packet network through which the local wireless access is available, the gateway adapted to forward the incoming call from the wireless office to the service node.

27. The system of claim 16 wherein the information associated with the mobile terminal is further associated with obtaining the cellular access to the mobile terminal.

28. The system of claim 27 wherein the information associated with the mobile terminal is called party identification corresponding with the cellular access to the mobile terminal.

29. The system of claim 27 wherein the information associated with the mobile terminal is a directory number associated with the cellular access to the mobile terminal.

30. The system of claim 16 wherein the control system is further adapted to:
detect a plurality of incoming calls originally intended to be routed to any one of a plurality of mobile terminals via cellular access and redirected by any one of a plurality of wireless offices facilitating the cellular access, the incoming calls including information associated with a corresponding one of the plurality of mobile terminals to which the incoming calls are intended; and
determine how to further process the incoming calls based on the information associated with the corresponding one of the plurality of mobile terminals.
